(19) United States
(12) Patent Application Publication
(10) Pub. No.: US 2010/0231765 A1
(43) Pub. Date: Sep. 16, 2010

(54) METHOD AND ARRANGEMENT FOR GENERATING A COLOR VIDEO SIGNAL

(75) Inventor: Christophe Kefeder, Eterville (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/293,813

(22) PCT Filed: Mar. 23, 2007
(86) PCT No.: PCT/IB2007/051035

§ 371 Date: Sep. 20, 2008

(30) Foreign Application Priority Data
Mar. 27, 2006 (EP) 06300289.3
Jul. 20, 2006 (EP) 06300822.1

(51) Int. Cl. H04N 9/04

(52) U.S. Cl. 348/273; 348/E09.01

(57) ABSTRACT

Method and apparatus for demosaicing a mosaic pattern of a color picture. To improve the picture quality, especially in case of a non-uniform mosaic pattern, a kernel of the mosaic pattern is selected, and the pixel values of the kernel are multiplied by coefficients that comply with a non-linear bi-dimensional interpolation algorithm. Additionally the pixels of the selected kernel may be multiplied by sharpening coefficients that comply with a derivative of the non-linear bi-dimensional interpolation algorithm.

### FIELD OF THE INVENTION

The invention relates to a method and arrangement for generating a color video signal from a light sensitive image sensor having a mosaic color filter array, comprising interpolating a new pixel value of a particular color from the color pixel values of color pixels of said particular color in a rectangular kernel by multiplying said color pixel values with a set of coefficients and summing the results of said multiplication to obtain the new pixel.

### BACKGROUND OF THE INVENTION

In usual image sensors for video- or photo-cameras the pixels for the colors red, green and blue lie in a “mosaic” pattern, also called Bayer pattern. Most common is the GRGB pattern comprising quadruplets of one red, one blue and two green pixels. The result is that only one quarter of the pixels provide red information, one quarter provides blue information and the remaining half of the pixels provides green information. To obtain a full (digital) signal for each of the colors, the missing pixels have to be interpolated by means of a so called “demosaicing algorithm”.

Many different methods for demosaicing exist, mostly by means of horizontal and vertical low pass filters used for interpolating the missing components. Another method is the “nearest neighbor replication” in which each interpolated output pixel is assigned the value of the nearest pixel in the input image. The nearest neighbor can be anyone of the upper, lower, left and right pixels. Still another method is the “bilinear interpolation” in which the average of two adjacent red or blue pixel values is assigned to the interpolated pixel at an originally green position there between, in which the average of four adjacent diagonal red/blue pixel values is assigned to the interpolated pixel at an originally blue/red position there between and in which the average of the upper, lower, right and left green pixel values is assigned to the interpolated pixel at an originally red or blue position there between. In the US Patent Application Publication US 2005/0031222 a not explained algorithm is used which is said to be “block shift invariant”.

A problem with all known interpolation algorithms however is that they operate satisfactorily only when the Bayer pattern is uniform i.e. when the pixel-phase is constant. However, if the Bayer data are subjected to a decimation or scaling operation, most importantly by pixel-binning, then the resulting Bayer pattern is not anymore uniform and then the prior art interpolation algorithms do not operate satisfactorily. Pixel binning is a process that reduces the number of pixels while the field of view (FoV) of the image is maintained. It enhances the sensitivity of a CCD or CMOS sensor in terms of the speed of image acquisition. This process involves taking groups of pixels of one color and combining such group of pixels into one “super” pixel. The pixel binning may take place in the analog domain whereby the charge of the group of pixels is combined so that the “super” pixel is capable of holding much more light. This has the effect of reducing the required exposure time. The pixel binning can also be done in the digital domain either by summing or by averaging the pixel values. Pixel binning may e.g. be used when a mega pixel sensor (>1.3 Mega-pixel) is used in video mode (720×576 pixels). Pixel binning provides a reduction of image resolution. However, a drawback of pixel binning is the loss of uniformity of the Bayer pattern with the result that the usual demosaicing algorithms give inferior results.

### SUMMARY OF THE INVENTION

It is an object of the present invention to provide an improved color video signal generation. The invention is defined by the independent claims. The dependent claims define advantageous embodiments. The method according to the present invention is characterized in that the coefficients are derived by a non-linear two-dimensional interpolation function. In one embodiment, the set of coefficients Cik substantially equals

$${C}_{ik} = {{\prod }^{n}}_{{j = 1}_{j \neq i}} ( \frac{x - {x}_{j}}{{x}_{i} - {x}_{j}} ) \cdot {\prod }_{{l = 1}_{l \neq k}}^{m} ( \frac{y - {y}_{l}}{{y}_{k} - {y}_{l}} ) ,$$

in which m and n are the number of rows and columns of the color pixels of said particular color in the selected rectangular kernel, in which xi, yk are the coordinates of said color pixels and in which x,y are the coordinates of the new pixel to be interpolated. This formula represents a two dimensional extension of the one dimensional Lagrange interpolating polynomial, see INTERPOLATION OF FUNCTIONS, by J. Szabados & P. Vértesi (Hungarian Acad. of Sci.), page 6, formula (1.3), ISBN: 9971509156—World Scientific. See also Eric W. Weisstein et al. “Lagrange Interpolating Polynomial.” From MathWorld—A Wolfram Web Resource, http://mathworld.wolfram.com/LagrangeInterpolatingPolynomial.html.

The binning scheme is usually characterized as “binning by N” wherein N is any positive integer larger than 1. In a “binning by N” scheme the pixel reduction is N2 and the pixel distance (the pixel phase) varies by 1, 2N-1, 1, 2N-1,1 . . . . In an embodiment of the invention the “binning by 2” scheme is preferred because it provides a practical pixel reduction by factor 4. Moreover with this binning scheme the digital multiplication by the coefficients is simpler because then all have denominators that are integer powers of 2.

The rectangular kernel of color pixels that is used for calculating a new pixel may have any suitable magnitude. Preferably, in a “binning by 2” scheme each kernel has a magnitude of 9×9 fields with 5×5 color pixels.

For the interpolation of a further new pixel the kernel may be shifted so as to keep the pixel to be interpolated approximately in the center of the kernel. However, when the Bayer pattern is non-uniform the risk exists that some kernels have less pixels than others. Therefore in an embodiment, it is preferred that the kernel is so selected that each of the kernels has the same (maximum) number of pixels.

It is often desirable to have a possibility to to increase the sharpness of the reproduced picture. Therefore the method according to the invention may be further characterized by multiplying the color pixels with a set of sharpening coefficients Sᵢₖ that complies with a derivative of said non-linear two dimensional interpolation function, by summing the result of said multiplying and by using the result of the summing to modify the value of the new pixel. Preferably the set of sharpening coefficients Sᵢₖ substantially complies with ΔCᵢₖ wherein Δ represents the two-dimensional Laplacian operator.

The invention also relates to an arrangement for generating a color video signal comprising a light sensitive image sensor having a mosaic color filter array with a Bayer pattern of color filters positioned on top of the sensor which is characterized by a video signal processor that is arranged to perform a non linear bi-dimensional interpolation algorithm by selecting kernels of the pixels read from the image sensor, multiplying the pixels of a particular color of a kernel by coefficients and adding the so multiplied pixels to constitute a new pixel of the color video signal. Such arrangement may be further characterized by a video signal processor that is arranged to perform a bi-dimensional sharpening algorithm by selecting kernels of pixels read from the image sensor, multiplying the pixels of a particular color of a kernel by sharpening coefficients and adding the so multiplied pixels to constitute sharpening information for a new pixel of the color video signal.

These and other aspects of the invention will be apparent from and elucidated with reference to the embodiments described hereinafter.

### BRIEF DESCRIPTION OF THE DRAWINGS

FIG. 1 shows a part of a usual RGBG Bayer pattern of color pixels resulting from a 4-color image sensor,

FIG. 2 shows an explanation of the “binning by 2” process,

FIG. 3 shows the Bayer pattern of FIG. 1 after being subjected to the “binning by 2” process shown in FIG. 2,

FIG. 4 shows the result of the demosaicing algorithm according to the present invention on a kernel of pixels of the Bayer pattern of FIG. 3,

FIG. 5 shows a first arrangement for carrying out the present invention, and

FIG. 6 shows a second arrangement for carrying out the present invention.

### DESCRIPTION OF EMBODIMENTS

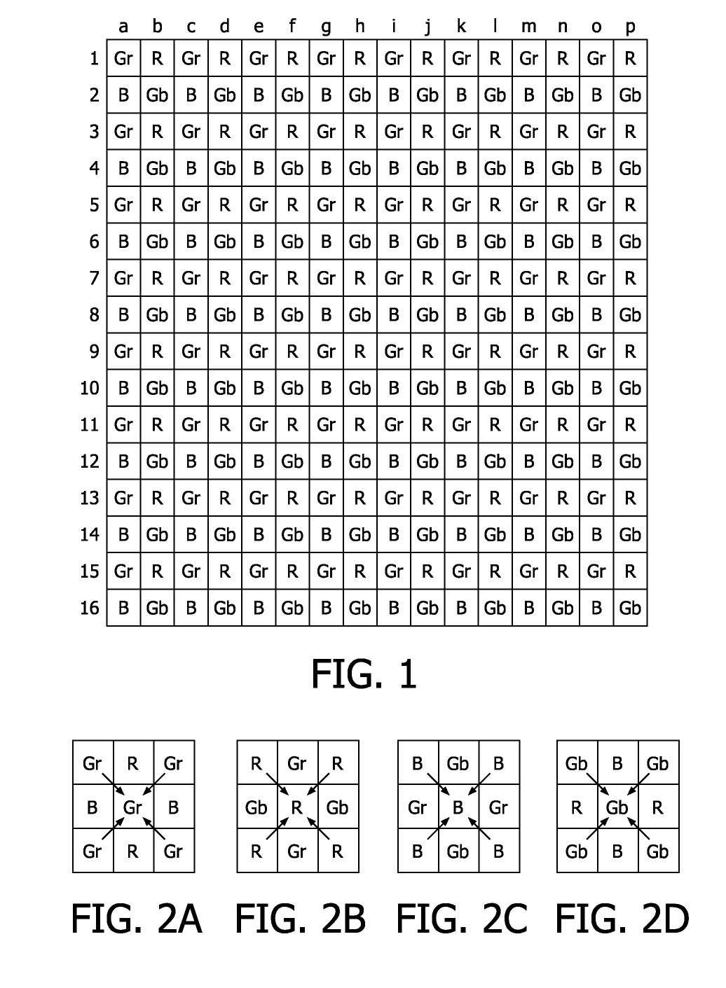

FIG. 1 schematically represents (part of) the Bayer pattern of a color filter array (CFA) that is usually placed in front of a CCD or CMOS image sensor to filter out the red, green and blue components of the light falling into it. The pattern consists of quadruplets of one red (R), one blue (B) and two green pixels (Gr, Gb) each. The two types of green pixels Gr and Gb respectively belong to the lines with the red and the blue pixels. Of course the Bayer pattern of FIG. 1 also represents the color pixels generated by the image sensor when light falls upon it through the color filter array.

The columns of the Bayer pattern are indicated by lower case reference characters a . . . p and the horizontal lines of the pattern are indicated by reference numerals 1 . . . 16. These reference characters and numerals allow indicating a block of pixels by its upper-left and lower-right pixels. E.g. the entire block of pixels shown in FIG. 1 may be indicated as the block [a1, p16].

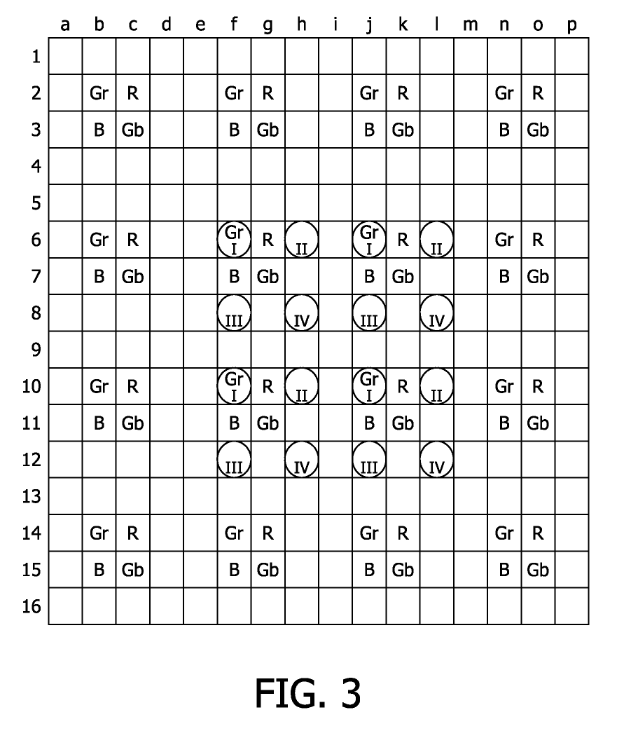

FIGS. 2 and 3 illustrate the pixel “binning by 2” scheme that is here supposed to be done in the analogue domain. Of a 3×3 block of pixels the four corner pixels have the same color and the charge of these four pixels is accumulated and stored in the center of the corresponding block of a similar array. This is shown in FIG. 2a for a block with Gr-corner pixels, in FIG. 2b for a block with R-corner pixels, in FIG. 2c for a block with B-corner pixels and in FIG. 2d for a block with Gb-corner pixels. The result of this binning process is shown in FIG. 3. It may be noted that e.g. the block [c1, e3] of the array of FIG. 1 cannot give a Gr-super pixel on location d2 of the array of FIG. 3 because the pixels c1 and c3 are already used in the block [a1,c3] and the pixels e1 and e3 are to be used in the block [e1,g3]. A pixel can only be used in one block, because the binning process “empties” the pixel in the original array. This is the reason why the array of FIG. 3 has a lot of fields without a color pixel. The result is that the array is non-uniform with a pixel phase 1-3-1-3-1. The pixel phase indicates that going from one pixel to the next pixel needs in turn 1 step, 3 steps, 1 step etc.

An alternative pixel-binning scheme is “binning by 3” in which, in a block of 5×5 pixels, all 8 pixels, that have the same color as the central field, have their charge transferred to that central field. An advantage of this binning scheme is that the original sensor array can be used to store the binned pattern, because the central field keeps its own charge and receives the charge from the 8 equally colored pixels. A drawback of “binning by 3” is that the number of fields without pixel is larger than with “binning by 2”. With “binning by 2” 75% of the fields of the Bayer pattern become empty whereas with “binning by 3” this percentage increases to nearly 89%.

The pixels of the Bayer pattern of FIG. 3 have to be scanned to derive there from the signal that has to be used to reproduce the picture. Because the one-color pixels of the Bayer pattern are scanned sequentially and the video signal has to contain the entire color information in parallel (simultaneously) the missing colors have to be filled in by means of a “demosaicing” algorithm.

In the Bayer pattern of FIG. 3 circles indicate the (part of the) pixels that have to be generated by the demosaicing algorithm. These new pixels not only contain the four colors in parallel but also have the property that their distribution over the entire Bayer pattern is uniform with pixel phase 2-2-2-2. It is further noted that these “new” pixels are not part of the Bayer pattern of FIG. 3 but they are shown therein to indicate their position in the generated video signal in relation to the one-color pixels Gr, R, Gb, B of the physical Bayer array.

Demosaicing algorithms usually perform their calculations onto a block of pixels (a Bayer kernel) around the pixel to be calculated. Such kernel is a square group of pixels whose size is usually [3×3], [5×5],[6×6]. The larger the size of the kernel is, the higher is the demosaicing complexity i.e. the number of additions and multiplications needed to calculate one pixel gets bigger.

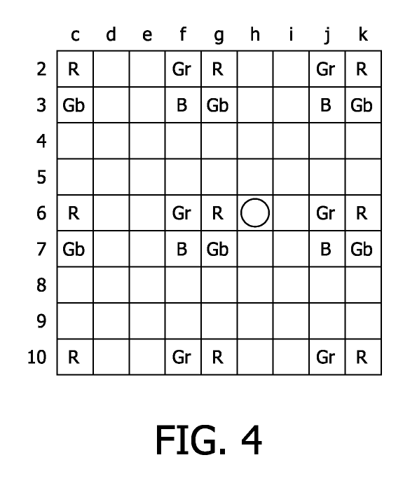

FIG. 4 shows the 5×5 pixel (9×9 field) kernel [c2, k10] that is selected for the calculation of the new pixel at location h6. Because it is of importance to have the new pixel approximately in the center of the kernel, the position of the kernel changes with the pixel to be calculated. The sequence hereafter represents the location of the new pixels shown in FIG. 3 to be calculated and the position of the kernel used for that calculation: f6,[b2,j10]; h6,[c2,k10]; j6,[f2, n10]; 16,[g2,o10] - - - f8,[3,j11]; h8,[c3,k11]; j8,[f3,n11]; 18,[g3,o11] - - - f10,[b6,j14]; h10,[c6,k14]; j10,[f6,n14]; l10,[g6,o14] - - - f12,[b7,j15]; h12,[c7,k15]; j12,[f7,n15]; l12,[g7,o15].

It can be easily ascertained that with this choice of the kernels each kernel contains the maximum of 5×5=25 color pixels. If, for instance, the kernel would be shifted uniformly with the new pixel to be calculated, the non-uniform distribution of the color pixels would cause some kernels to have less color pixels than other kernels.

The new pixel is calculated from the color pixels of the kernel by means of a demosaicing algorithm that is based on the non-linear and two dimensional equation:

$${C}_{ik} = {{\prod }^{n}}_{{j = 1}_{j \neq i}} ( \frac{x - {x}_{j}}{{x}_{i} - {x}_{j}} ) \cdot {\prod }_{{l = 1}_{l \neq k}}^{m} ( \frac{y - {y}_{l}}{{y}_{k} - {y}_{l}} ) . \qquad ( I )$$

Herein is n the number of columns in the kernel that contain pixels of a particular color and m the number of rows containing pixels of that color. The subscripts i and k indicate the rank number of a color pixel in its column and row respectively. x and y define the location in the kernel of the new pixel to be calculated and xi and yk define the location of each particular color pixel in the kernel. Cik is the coefficient with which the value (Pik) of color pixel i,k is multiplied to define its contribution in the value P(x,y) of the color component of the new pixel according to:

$$P ( x , y ) = {\sum }_{i = 1}^{n} {\sum }_{k = 1}^{m} {C}_{ik} {P}_{ik} . \qquad ( II )$$

By way of example the coefficients for the new pixel on h6 in the kernel [c2, k10] of FIG. 4 are calculated with the above given equation (I). In this calculation the position of the origin of the x,y-coordinates can be chosen arbitrarily. In this example the origin is chosen in the field c10 for all the four colors R, Gb, B and Gr. Therefore the coordinates of the new pixel on h6 are x=5 and y=4.

From FIG. 4 it may be seen that for the red color pixels of the kernel the following applies:
n=3 m=3
x1=0 y1=0
x2=4 y2=4
x3=8 y3=8

With equation (I) the coefficients Cik are then as follows:

$$\begin{matrix}{C}_{13} & {C}_{23} & {C}_{33} \\ {C}_{12} & {C}_{22} & {C}_{32} \\ {C}_{11} & {C}_{21} & {C}_{31}\end{matrix} = \begin{matrix}0 & 0 & 0 \\ - 3 / 32 & 30 / 32 & 5 / 32 \\ 0 & 0 & 0\end{matrix}$$

From this matrix it follows that the red-component of the new pixel has 30/32 of the value of the red pixel on g6 (which lies close to the new pixel) plus 5/32 of the value of the red pixel on k6 (which lies farther from the new pixel) minus 3/32 of the value of the red pixel on c6 (which lies still farther from the new pixel with the g6-pixel in between. The other red pixels do not contribute to the new pixel because the pixels c6, g6 and k6 lie on the same horizontal line with the new pixel.

The same calculation can be done for the other color pixels of the kernel. For the Gb pixels of the kernel the following holds:
n=3 m=2
x1=0 y1=3
x2=4 y2=7
x3=8

This gives the coefficients:

$$\begin{matrix}{C}_{12} & {C}_{22} & {C}_{32} \\ {C}_{11} & {C}_{21} & {C}_{31}\end{matrix} = \begin{matrix}- 3 / 128 & 30 / 128 & 5 / 128 \\ - 9 / 128 & 90 / 128 & 15 / 128\end{matrix}$$

It is noted that the sum of all coefficients is always equal to 1. This implies that, when all the kernel pixels of a particular color have the same value, also the new pixel will get that value for this color.

The values for the blue color pixels are:
n=2 m=2
x1=3 y1=3
x2=7 y2=7
   giving the coefficient matrix:

$$\begin{matrix}{C}_{12} & {C}_{22} \\ {C}_{11} & {C}_{21}\end{matrix} = \begin{matrix}2 / 16 & 2 / 16 \\ 6 / 16 & 6 / 16\end{matrix}$$

and the values for the Gr color pixels are:
n=2 m=3
x1=3 y1=0
x2=7 y2=4
   y3=8
      giving the matrix:

$$\begin{matrix}{C}_{13} & {C}_{23} \\ {C}_{12} & {C}_{22} \\ {C}_{11} & {C}_{21}\end{matrix} = \begin{matrix}0 & 0 \\ 1 / 2 & 1 / 2 \\ 0 & 0\end{matrix}$$

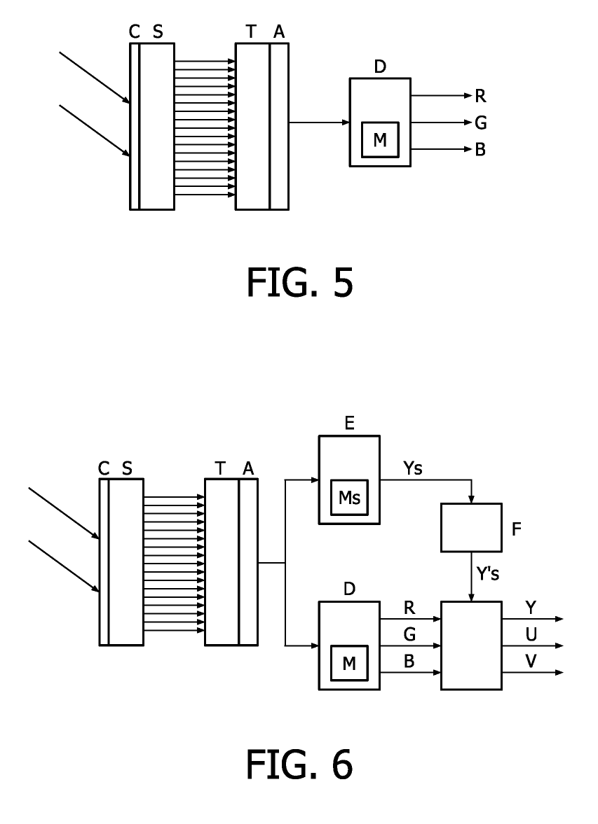

The arrangement of FIG. 5 comprises a sensor array S that receives incoming light through a color filter array C. The pixel information read from the sensor is “binned by 2” and stored in a second array T and the so binned pixels are subsequently converted to digital signals of e.g. 10 bits per pixel in an analog to digital converter A. The digital signals are subsequently processed in a demosaicing processor D. When the binning operation is performed digitally then the array T will be placed after the AD converter A. The binning can also be performed “on the fly” when the pixel data are sent line-by-line and pixel-by-pixel to the processor D. In the processor D the signals are subjected to the demosaicing algorithm described above to generate the four parallel color video signals. Averaging the signals Gr and Gb deliver the green signal G.

The processor D may obtain the new pixels by repeatedly calculating the equation I for each pixel. However it is more convenient to have the once calculated coefficients Cik stored in a memory M of the processor D, to multiply the value of the color pixels with these stored coefficients and to add the so obtained contributions from each color pixel to obtain the value of the new pixel. The number of coefficients to be stored in the memory M is limited because there are only four kernel types. These kernel types are shown in FIG. 3 in their respective new pixels circles by the roman numerals I, II, III and IV. Kernel type II is subject to FIG. 4 and it has been shown above that this kernel needs 25 coefficients (9 for the R-pixels, 6 for the Gb-pixels, 4 for the B-pixels and 6 for the Gr-pixels). Each of the other three kernel types also needs 25 (other) coefficients so that for carrying out the demosaicing algorithm 100 coefficients need to be stored.

As shown above the coefficients are all fractions with a denominator that is a power of 2. This makes digital calculation relatively easy. The denominator stems from the fact that in a “binning by 2” pattern the distance between rows or columns of one color is always an integer power of 4. This advantage does not exist when “binning by 3” is applied because then the distance between rows or columns of one color is 6 or a multiple of 6.

A further embodiment of the invention relates to the feature of image sharpening. For this purpose sharpening coefficients are present that, just like the interpolation coefficients, have to be multiplied with the pixel-values of the selected kernel. The results of this multiplication are added together and the so obtained sum of the contributions of the color pixels is used to modify the respective color of the new pixel.

The required sharpening coefficients Sᵢₖ are calculated by taking the first or second order derivative of the two dimensional function (I) that is given above for calculating the interpolation coefficients Cᵢₖ. With a first order derivative the edges of the image will be enhanced whereas a second order derivative may serve to increase the details of the image. A preferred example of the latter sharpening method is to use the well-known Laplacian operator Δ, which provides a second-order two-dimensional partial-derivative operation. This operator Δ, exercised on the above given interpolation function (I), gives:

$${S}_{ik} = \frac{{\partial }^{2}}{\partial {x}^{2}} ( {\prod }_{{j = 1}_{j \neq i}}^{n} ( \frac{x - {x}_{j}}{{x}_{i} - {x}_{j}} ) \cdot {\prod }_{{l = 1}_{l \neq k}}^{m} ( \frac{y - {y}_{l}}{{y}_{k} - {y}_{l}} ) ) + \frac{{\partial }^{2}}{\partial {y}^{2}} ( {{\prod }^{n}}_{{j = 1}_{j \neq i}} ( \frac{x - {x}_{j}}{{x}_{i} - {x}_{j}} ) \cdot {\prod }_{{l = 1}_{l \neq k}}^{m} ( \frac{y - {y}_{l}}{{y}_{k} - {y}_{l}} ) ) or \\ {S}_{ik} = \frac{{\partial }^{2}}{\partial {x}^{2}} ( {\prod }_{{j = 1}_{j \neq i}}^{n} ( \frac{x - {x}_{j}}{{x}_{i} - {x}_{j}} ) ) \cdot {\prod }_{{l = 1}_{l \neq k}}^{m} ( \frac{y - {y}_{l}}{{y}_{k} - {y}_{l}} ) + {\prod }_{{j = 1}_{j \neq i}}^{n} ( \frac{x - {x}_{j}}{{x}_{i} - {x}_{j}} ) \cdot \frac{{\partial }^{2}}{\partial {y}^{2}} ( {\prod }_{{l = 1}_{l \neq k}}^{m} ( \frac{y - {y}_{l}}{{y}_{k} - {y}_{l}} ) ) \qquad ( III )$$

For n=3 and m=3 this equation gives then for the coefficient S₁₁:

$${S}_{11} = \frac{( x - {x}_{2} ) ( x - {x}_{3} ) + ( y - {y}_{2} ) ( y - {y}_{3} )}{( {x}_{1} - {x}_{2} ) ( {x}_{1} - {x}_{3} ) ( {y}_{1} - {y}_{2} ) ( {y}_{1} - {y}_{3} )} .$$

For the other coefficients S₁₂, S₁₃, S₂₁, S₂₂, S₂₃, S₃₁, S₃₂ and S₃₃ similar expressions with changed indices apply.
For n=3, m=2 the equations for the sharpening coefficients become simpler; e.g. for S₁₁:

$${S}_{11} = \frac{( y - {y}_{2} )}{( {x}_{1} - {x}_{2} ) ( {x}_{1} - {x}_{3} ) ( {y}_{1} - {y}_{2} )} and for$$

$$n = 2 , m = 3 {S}_{11} = \frac{( x - {x}_{2} )}{( {x}_{1} - {x}_{2} ) ( {y}_{1} - {y}_{2} ) ( {y}_{1} - {y}_{3} )}$$

For n=2, m=2 all the sharpening coefficients are 0.
With these equations the sharpening coefficients for the pixel-kernel of FIG. 4 can be calculated with the following result:

$$For the red pixels \text{:} \begin{matrix}{S}_{13} & {S}_{23} & {S}_{33} \\ {S}_{12} & {S}_{22} & {S}_{32} \\ {S}_{11} & {S}_{21} & {S}_{31}\end{matrix} = \begin{matrix}- 3 / 1024 & 30 / 1024 & 5 / 1024 \\ 38 / 1024 & - 124 / 1024 & 22 / 1024 \\ - 3 / 1024 & 30 / 1024 & 5 / 1024\end{matrix}$$

$$For the Gb pixels \text{:} \begin{matrix}{S}_{12} & {S}_{22} & {S}_{32} \\ {S}_{11} & {S}_{21} & {S}_{31}\end{matrix} = \begin{matrix}1 / 128 & - 2 / 128 & 1 / 128 \\ 3 / 128 & - 6 / 128 & 3 / 128\end{matrix}$$

$$For the Gr pixels \text{:} \begin{matrix}{S}_{13} & {S}_{23} \\ {S}_{12} & {S}_{22} \\ {S}_{11} & {S}_{21}\end{matrix} = \begin{matrix}2 / 128 & 2 / 128 \\ - 4 / 128 & - 4 / 128 \\ 2 / 128 & 2 / 128\end{matrix}$$

$$For the blue pixels \text{:} \begin{matrix}{S}_{12} & {S}_{22} \\ {S}_{11} & {S}_{21}\end{matrix} = \begin{matrix}0 & 0 \\ 0 & 0\end{matrix}$$

It is noted that the sum of all coefficients in a matrix is always equal to 0. This implies that, when all the pixels of a particular color in the kernel have the same value, no sharpening will take place.

The storage of the sharpening coefficients and the multiplication of these coefficients with the respective pixel values may be done in the same processor D described above with reference to FIG. 5. In that case this processor may include means to multiply the pixel values with the interpolation coefficients Cᵢₖ, means to sum the results of this multiplication to create the interpolated new pixel, means to multiply the same pixel values with the sharpening coefficients Sᵢₖ, means to sum the results of this multiplication to create the sharpening information for the new pixel and finally means to add the sharpening information to the interpolated (new) pixel. It is also possible to store the sum of the two coefficients Cᵢₖ+Sᵢₖ in a single memory location and to multiply the pixel values with the so summed coefficients. A drawback of both solutions however is that it is not possible to add post-processing features of the sharpness information such as noise coring, sharpness gain adjustment and soft sharpness. An arrangement that allows such sharpness post-processing is shown in FIG. 6.

The arrangement of FIG. 6 contains a sharpening processor E which contains a memory Ms for holding the sharpening coefficients Sᵢₖ. The sharpening-processor E receives from the AD converter A the same pixel data as the processor D, multiplies these pixel data with the sharpening coefficients Cᵢₖ and adds the result of this multiplication to obtain the sharpening color components Rs, Gbs, Grs and Bs. Preferably these sharpening color components are combined to a sharpening luminance component Ys e.g. according to the equation Ys=0,3Rs+0,3Gbs+0,3Grs+0,1Bs. Subsequently the sharpening luminance component Ys is applied to a post-processing unit F in which desirable post-processing such as noise coring, sharpness gain and soft sharpness are performed. The then obtained component Y's is subsequently added to the luminance component of an RGB-to-YUV matrix.

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention may be implemented by means of hardware comprising several distinct elements, and/or by means of a suitably programmed processor. In the device claim enumerating several means, several of these means may be embodied by one and the same item of hardware. The mere fact that certain measures are recited in mutually different dependent claims does not indicate that a combination of these measures cannot be used to advantage.

1. Method of generating a color video signal from a light sensitive image sensor having a mosaic color filter array, the method comprising the steps of interpolating a new pixel value of a particular color from color pixel values of color pixels of said particular color in a rectangular kernel by multiplying said color pixel values with a set of coefficients and summing the results of said multiplication to obtain the new pixel value, characterized in that the set of coefficients complies with a non-linear two-dimensional interpolation function.

2. Method as claimed in claim 1, wherein the set of coefficients Cik substantially complies with
$${C}_{ik} = {{\prod }^{n}}_{{j = 1}_{j \neq i}} ( \frac{x - {x}_{j}}{{x}_{i} - {x}_{j}} ) \cdot {\prod }_{{l = 1}_{l \neq k}}^{m} ( \frac{y - {y}_{l}}{{y}_{k} - {y}_{l}} ) ,$$
in which m and n are the number of rows and columns of the color pixels of said particular color in the selected rectangular kernel, in which xi, yk are the coordinates of said color pixels, and in which x, y are the coordinates of a pixel the new pixel value of which is to be interpolated.

3. Method as claimed in claim 1, wherein for each pixel a kernel of color pixels is selected from a non-uniform pattern of pixels in such a manner, that each of the kernels has the same number of color pixels.

4. Method as claimed in claim 3, wherein the non-uniform pattern is created by a “binning by 2” process, and each kernel comprises 9×9 fields with 5×5 color pixels.

5. Method as claimed in claim 1, further comprising characterized increasing the sharpness of the color video signal comprising the steps of multiplying said color pixels with a set of sharpening coefficients Sᵢₖ, summing the result of said multiplying step and using the result of said summing to modify the value of the new pixel, wherein the set of sharpening coefficients complies with a second order derivative of said non-linear two-dimensional interpolation function.

6. Method as claimed in claims 5, wherein the set of coefficients Cik substantially complies with
$${C}_{ik} = {{\prod }^{n}}_{{j = 1}_{j \neq i}} ( \frac{x - {x}_{j}}{{x}_{i} - {x}_{j}} ) \cdot {\prod }_{{l = 1}_{l \neq k}}^{m} ( \frac{y - {y}_{l}}{{y}_{k} - {y}_{l}} ) ,$$
in which m and n are the number of rows and columns of the color pixels of said particular color in the selected rectangular kernel, in which xi, yk are the coordinates of said color pixels, and in which x, y are the coordinates of a pixel the new pixel value of which is to be interpolated, wherein the set of sharpening coefficients Sᵢₖ substantially complies with ΔCᵢₖ, wherein Δ represents the two-dimensional Laplacian operator.

7. Arrangement for generating a color video signal, the arrangement comprising:
a light sensitive image sensor having a mosaic color filter array, and
a video signal processor for performing a non linear bi-dimensional interpolation algorithm by selecting kernels of the pixels read from the image sensor, multiplying pixel values of a particular color of a kernel by coefficients to obtain multiplied pixel values, and adding the multiplied pixel values to constitute a new pixel value of the color video signal.

8. Arrangement as claimed in claim 7, further comprising a video signal processor for performing a bi-dimensional sharpening algorithm by selecting kernels of pixels read from the image sensor, multiplying the pixels of a particular color of a kernel by sharpening coefficients, and adding the so multiplied pixels to constitute sharpening information for a new pixel of the color video signal.
